(19) United States
(12) Patent Application Publication
(10) Pub. No.: US 2010/0266929 A1
(43) Pub. Date: Oct. 21, 2010

(54) CATALYST HAVING A DEHYDROGENATION FUNCTION OR HYDROGENATION FUNCTION, FUEL CELL USING THE CATALYST AND HYDROGEN STORAGE/SUPPLY DEVICE

(76) Inventors: Hiroshi Kanemoto, Hitachinaka (JP); Takao Ishikawa, Hitachi (JP); Masafumi Noujima, Tokai (JP); Takeyuki Itabashi, Yasugi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/159,220

(22) PCT Filed: Dec. 20, 2006
(86) PCT No.: PCT/JP2006/325336

§ 371 Date: Jul. 8, 2010

(30) Foreign Application Priority Data
Dec. 28, 2005 (JP) 2005-376859

(51) Int. Cl. H01M 8/10; B01J 35/04; B65B 3/00

(52) U.S. Cl. 429/488; 502/4; 206/6

(57) ABSTRACT

An object of the invention is to provide a catalyst of high activity having a dehydrogenation function or hydrogenation function, to provide a fuel cell with a high output density, and further to provide a hydrogen storage/supply device, with which hydrogen is stored or supplied in a high efficient manner.

In order to achieve the above object, a porous oxide film of a metal oxide is formed on a hydrogen separation membrane surface of a catalyst having a dehydrogenation function or hydrogenation function and the hydrogen separation membrane is arranged so as to be partially exposed to at the interface with the porous oxide film. In doing so, hydrogen generated on the catalyst can quickly diffuse into the hydrogen separation membrane thereby efficiently releasing the hydrogen to outside of the reaction system. Eventually, the reaction efficiency can be improved. As to the fuel cell of the invention, the catalyst having the dehydrogenation function or hydrogenation function is used in a fuel cell and further in a hydrogen storage/supply device.

### TECHNICAL FIELD

This invention relates to a catalyst having a dehydrogenation function or hydrogenation function wherein hydrogen is generated or stored by utilizing dehydrogenation or hydrogenation between a hydrogen donor changing to a dehydride by releasing hydrogen and a hydrogen absorbing medium consisting of a hydride that reacts with the hydrogen to store the hydrogen. The invention also relates to a fuel cell using the catalyst and a hydrogen storage/supply device.

### TECHNICAL BACKGROUND

In the face of a serious problem on global warming caused by carbon dioxide and the like, attention has been paid to hydrogen used as a clean energy source expectable for the next generation in place of fossil fuels. In order to promote energy-savings by reducing CO₂ emissions by effective utilization of energy, attention has also been drawn to cogeneration of power-generation facilities. In recent years, technological developments of fuel cell power generation systems, in which electric power is generated by using hydrogen prepared by modification of methane or methanol or the like with reformers, have been rapidly promoted for use of the systems as a power source for a diversity of applications to automobiles, consumer power-generation facilities, vending machine, mobile devices and the like.

The fuel cell is able to generate electricity at the time when water is produced by reaction hydrogen with oxygen and also to provide hot water and carry out air conditioning by utilizing the heat energy generated at the same time, thus being applied as a consumer distributed power supply. Among various fuel cells using a solid electrolyte membrane, there are a low temperature type fuel cell using a solid polymer membrane and a high temperature type fuel cell such as a solid oxide type or the like.

The solid polymer membrane-type fuel cell makes use of a hydrogen fluoride-based polymer membrane, as an electrolyte membrane sandwiched between electrodes. Under existing circumstances, the solid polymer membrane type fuel cell is generally operated within a range of about 150° C. or below. The solid oxide type fuel cell is one which uses an inorganic thin film of zirconia or the like as an electrolyte membrane sandwiched between electrodes. The resistance of these electrolyte membranes tends to increase at lower temperatures. To suppress the membrane resistance within a practical range, operations at relatively high temperature are needed for the fuel cell. As it stands now, the solid oxide type fuel cell is operated generally at temperatures not lower than about 700° C.

In recent years, as set forth in Patent Literature 1 (Japanese Laid-open Patent No. 2004-146337), there is a proposed fuel cell whose system efficiency is more excellent. A fuel cell described in Patent Literature 1 is one that is operable within a middle temperature range of 150-700° C. and has a structure wherein an electrolyte membrane is sandwiched between hydrogen separation membranes. The fuel cell generates electric power by using hydrogen supplied from an external reformer capable of generating the hydrogen. The formation as to a very thin solid electrolyte of about several hundreds of nm in thickness on the surface of the hydrogen separation membrane enables the fuel cell to be operated in the middle temperature range.

On the other hand, a major problem is involved in transportation, storage and supply systems of hydrogen, which are essential for use of hydrogen as a fuel. Hydrogen is gaseous in nature at room-temperature and is more difficult in storage and transportation than liquids and solids. Additionally, hydrogen is a flammable substance, for which care should be taken to handling thereof.

Recently, for a method of storing hydrogen which is excellent in safety of transportability and storage capability, attention has been paid to an organic hydride system using a hydrocarbon such as cyclohexane, decalin or the like. These hydrocarbons are liquid at room-temperature with excellent transportability.

For instance, although benzene and cyclohexane are cyclic hydrocarbons that have the same carbon atom numbers, respectively, benzene is an unsaturated hydrocarbon wherein a carbon-carbon bond is a double bond, whereas cyclohexane is a saturated hydrocarbon having no double bond. Cyclohexane is obtained by hydrogenation to benzene, and benzene is obtained by dehydrogenation to cyclohexane. More particularly, when using the hydrogenation and dehydrogenation to these hydrocarbons, storage and supply of hydrogen is enabled.

Aside from the fact that organic hydrides are utilized for such hydrogen storage and supply systems as set out above, fuel cells using organic hydrides as a fuel have been recently developed. For instance, as described in Patent Literature 2 (Japanese Laid-open Patent No. 2003-45449) or Patent Literature 3 (Japanese Laid-open Patent No. 2004-192834), there are more compact fuel cells wherein a process of dehydrogenation or hydrogenation of an organic hydride is internalized.

The fuel cell set out in Patent Literature 2 is able to realize chemical power generation by direct use of an organic hydride. Moreover, hydrogen generated by water-electrolysis can be subjected to hydrogenation with a dehydride to prepare an organic hydride.

In the fuel cell described in Patent Literature 3 (Japanese Laid-open Patent No. 2004-192834), a fuel electrode side-reaction container is provided with an organic hydride retainer, a dehydrogenation catalyst and a heater; an organic hydride is dehydrogenated; the resulting hydrogen is separated by means of a hydrogen separation membrane and is converted to hydrogen ions by use of a platinum catalyst; and the hydrogen ions are reacted with oxygen ions in a positive electrode side-reaction container to generate electric power.

Patent Literature 1: Japanese Laid-open Patent No. 2004-146337

Patent Literature 2: Japanese Laid-open Patent No. 2003-45449

Patent Literature 3: Japanese Laid-open Patent No. 2004-192834

### DISCLOSURE OF THE INVENTION

### Problem to be Solved by the Invention

However, the techniques set out in the Patent Literatures 1, respectively, have the problems.

More particularly, the fuel cell described in Patent Literature 1 is supplied with hydrogen or a hydrogen-rich gas to generate electricity, so that hydrogen separately prepared by a reformer is necessary. If such a fuel cell is mounted in vehicles, it is necessary to provide a fuel cell system to which hydrogen prepared by a vehicle-mounted reformer is supplied as fuel, or a fuel cell system wherein hydrogen prepared at an off-site location is charged into a hydrogen cylinder and is then supplied to the fuel cell, thus the system becoming large in size as a whole. Additionally, in the case of that a hydrogen cylinder is mounted in vehicles, it is needed to exercise care for handling the hydrogen gas. For instance, since high temperatures of 600-700° C. are necessary for reforming methane or the like, hydrogen supply at lower temperature conditions are desirable. Moreover, in the case of that a catalyst for promoting the reaction is formed on the surface of a hydrogen separation membrane, it is necessary to fix the catalyst to the separation membrane well by pressure bonding or the like. This results in a reduced effective utilization area of the hydrogen separation membrane and it becomes necessary to add materials such as a binder, thus causing an output density to be lowered.

The fuel cell described in Patent Literature 2 includes a dehydrogenation catalyst formed on the surface of an electrolyte membrane, to which an organic hydride is directly fed. This causes an output density to be lowered due to a so-called crossover where a fuel permeates into the electrolyte membrane and undergoes a chemical reaction at an oxygen electrode although a degree thereof is smaller when compared with a direct methanol fuel cell. Moreover, in the case of that a solid polymer membrane is utilized as an electrolyte membrane, a problem is involved in that the membrane gradually dissolves by contact with an organic hydride and dehydride, thereby undergoes degradation.

The fuel cell described in Patent Literature 3 needs both of a catalyst for dehydrogenation and a catalyst for fuel electrode; the fuel cell has to have a structure where the dehydrogenation catalyst, hydrogen separation membrane and fuel electrode catalyst are, respectively, insulated therebetween. Such a structure becomes cause of needing a large number of members and a high cost thereof.

When a liquid fuel is reacted on a fuel electrode to generate hydrogen, gaseous hydrogen involves a steep volumetric change, invariably generating shock wave relative to the catalyst. Accordingly, the catalyst used is required to be high in mechanical strength. The catalyst firmly fixed such as by pressure bonding does not function as a stable catalyst.

The invention has been made to solve the above problems. An object of the invention is to provide a catalyst whit high activity having a stable dehydrogenation function or hydrogenation function wherein hydrogen is generated or stored by utilizing dehydrogenation or hydrogenation between a hydrogen donor changing to a dehydride by releasing hydrogen and a hydrogen absorbing medium consisting of a hydride that that reacts with the hydrogen to store the hydrogen.

Furthermore, the provision of a fuel cell of a high output density using the catalyst having a dehydrogenation function or hydrogenation function, and the provision of a hydrogen storage/supply device capable of storing or supplying hydrogen in an efficient manner by use of the catalyst having a dehydrogenation function or hydrogenation function.

### Means for Solving the Problem

In order to achieve the above object, the catalyst of the invention having a dehydrogenation or hydrogenation function is arranged so that a porous oxide film of a metal oxide is formed on a surface of a hydrogen separation membrane as a catalyst carrier. Thereby, the hydrogen separation membrane is partially exposed at an interface with the porous oxide film.

The catalyst has the porous oxide film of at least one metal oxide selected from a group consisting of niobium oxide, tantalum oxide, zirconium oxide, aluminium oxide, sodium niobate, potassium niobate, lithium niobate, sodium tantalate, potassium tantalate and lithium tantalate as a catalyst carrier.

Preferably, the fuel channel layer or the oxygen channel layer are made of materials of high heat conduction, respectively.

More particularly, by forming the above-mentioned catalyst directly on the hydrogen separation membrane, an exposed portion of the hydrogen separation membrane is allowed to exist at the interface between the catalyst carrier and the hydrogen separation membrane. Hydrogen generated on the catalyst can be rapidly diffused into the hydrogen separation membrane to efficiently release the hydrogen to outside of the reaction system. Eventually, the reaction efficiency can be improved.

Since a metal oxide is used as a catalyst carrier, diffusion of a hydride from the catalyst carrier to a catalyst metal and desorption of an aromatic compound formed as a product can be more facilitated as compared with the case of using a carbon material such as active carbon or the like as the catalyst carrier.

Further, the surface area is increased by porosizing a metal oxide to improve an efficiency of contact between a fuel and the catalyst. Therefore, the catalyst can be effectively utilized to secure a predetermined reaction velocity at low temperatures.

Next, the fuel cell of the invention makes effective use of the catalyst having a dehydrogenation function or hydrogenation function. More particularly, in a fuel cell comprising a fuel electrode, an oxygen electrode, an electrolyte membrane provided between the fuel electrode and the oxygen electrode, a fuel channel layer provided on the fuel electrode, and an oxygen channel layer provided on the oxygen electrode which are laminated at least one-by one, in at least one layer and are covered with a casing, the fuel electrode comprises a hydrogen separation membrane and a catalyst formed on the membrane surface. The catalyst includes a porous oxide film of a metal oxide as a catalyst carrier, and is configured to generate hydrogen by utilizing the dehydrogenation between a hydrogen donor changing to a dehydride by releasing hydrogen and a hydrogen absorbing medium consisting of a hydride that reacts with the hydrogen to store the hydrogen. In the fuel cell of the invention, electrons taken out upon the generation of hydrogen are used for electric generation.

The hydrogen separation membrane is partially exposed at the interface with the porous oxide film.

The catalyst has the porous oxide film of at least one metal oxide selected from a group consisting of niobium oxide, tantalum oxide, zirconium oxide, aluminium oxide, sodium niobate, potassium niobate, lithium niobate, sodium tantalate, potassium tantalate and lithium tantalate as a catalyst carrier.

Further, the hydrogen separation membrane is made of palladium, niobium, tantalum, zirconium, vanadium and an alloy containing at least a part thereof.

That is, with the fuel cell with the above-mentioned structure, a fuel fed to the fuel electrode undergoes dehydrogenation by the reaction of the catalyst to generate hydrogen. Upon generation of hydrogen, electrons are taken out and utilized for electric generation after passage, for example, through an external circuit. On the other hand, generated hydrogen is quickly passed through the hydrogen separation membrane integrated with the catalyst carrier and the electrolyte membrane, followed by reaction with oxygen fed to the oxygen electrode to produce water.

It will be noted that when the catalyst is formed directly on the hydrogen separation membrane, an exposed portion of the hydrogen separation membrane is allowed to exist at the interface between the catalyst carrier and the hydrogen separation membrane. The hydrogen formed on the catalyst can be quickly diffused into the hydrogen separation membrane, thus enabling the hydrogen to be efficiently removed to outside of the reaction system. Eventually, the reaction efficiency can be improved and thus, a fuel cell of high output density can be provided.

By using a metal oxide as a catalyst carrier, diffusion of a hydride from the catalyst carrier to a catalyst metal and elimination of an aromatic compound formed as a product can be more facilitated when compared with the case of using a carbon material such as active carbon.

Preferably, the fuel channel layer or the oxygen channel layer is made of a high thermal-conductive material.

Further, in a hydrogen storage/supply device of the invention, the catalyst having a dehydrogenation or hydrogenation function is used for the hydrogen storage/supply device.

More particularly, according to the fuel cell, electric generation can be realized by feeding a hydride and air or oxygen to the fuel electrode and the oxygen electrode, respectively. Alternatively, a dehydride and water may be fed to the fuel electrode and the oxygen electrode, respectively, and electrolyzed to hydrogenate the dehydride in a high efficiency thereby preparing a hydride. That is, the cell can be utilized only for the preparation of a hydride.

It will be noted that the hydride used as a fuel fed to the fuel cell or hydrogen storage/supply device of the invention is organic hydride made of at least one of isopropanol, cyclohexane, methylcyclohexane, dimethylcyclohexane, decalin, methyl decalin, tetradecahydroanthracene, bicyclohexyl, and alkyl-substituted product thereof. Alternatively, there may be mentioned at least one boron hydride compound selected from a group consisting of LiBH₄, NaBH₄, KBH₄ and Mg (BH₄)₂. Still alternatively, there may be mentioned at least one selected from a group consisting of bioethanol and biomethanol.

The organic hydrides are able to store hydrogen by adding hydrogen to carbon-carbon double bonds. The hydrogen donor after the hydrogenation releases hydrogen and changes to the original hydrogen absorbing medium. More particularly, the organic hydride becomes a carrier suited for recycling hydrogen. Both the dehydrogenation and hydrogenation proceed according to a catalytic reaction. Especially, the dehydrogenation is an endothermic reaction. In order to permit the reaction to proceed efficiently, it is necessary that heat be supplied from outside so as not to lower a catalyst temperature.

The boron hydride compound has a very high content of hydrogen and, for example, NaBH₄ contains 10.6 wt % of hydrogen. Since NaBH₄ reacts with moisture in air when left as it is, it is stabilized and stored by dissolution in an alkaline aqueous solution such as of NaOH or the like. The stabilized NaBH₄ is able to generate hydrogen by hydrolysis in the presence of a catalyst. The dehydrogenation of a boron hydride compound is an exothermic reaction. In order to control the reaction, cooling is necessary so as not to raise a catalyst temperature.

Further, bioethanol is prepared by alcoholic fermentation of starchy materials and carbohydrates such as wheat, sugarcane, corn and the like, or known methods of preparation from cellulose derived from forest resources (needle leaf trees, broad leaf trees, bamboo grass, bamboo plant and the like), waste stuffs from forest products (forest remaining materials, thinned wood, remaining and waste wood, factory remaining and waste materials, building waste materials, waste paper and the like), and agricultural waste materials (rice straw, rice hull, bagasse and the like). Biomethanol can also be prepared by gasifying biomass, such as forest resources (needle leaf trees, broad leaf trees, bamboo grass, bamboo plant and the like), waste stuffs from forest products (forest remaining materials, thinned wood, remaining and waste wood, factory remaining and waste materials, building waste materials, wastepaper and the like), and agricultural waste materials (rice straw, rice hull, bagasse and the like), under high temperature conditions and synthesizing it. Like the organic hydride, the dehydrogenation reaction is an endothermic reaction, for which heat should be efficiently supplied from outside.

### EFFECTS OF THE INVENTION

As stated above, according to the invention, it is possible to provide a catalyst of high activity having a stable dehydrogenation function or hydrogenation function and capable of generating hydrogen by utilizing the dehydrogenation or hydrogenation between a hydrogen donor changing to a dehydride by releasing hydrogen and a hydrogen absorbing medium consisting of a hydride that reacts with the hydrogen to store the hydrogen.

In the practice of the invention, a fuel cell of high output density can be provided by using the catalyst having the dehydrogenation function or hydrogenation function.

Further, according to the invention, it is possible to provide a hydrogen storage/supply device by using the catalyst having the dehydrogenation function or hydrogenation function whereby hydrogen is stored or supplied in a high efficiency.

### BEST MODE FOR CARRYING OUT THE INVENTION

Embodiments of the invention are described in detail by way of examples.

FIG. 1 shows a fuel cell embodying the invention.

A fuel cell 1 is comprised of a fuel electrode 2, an oxygen electrode 3, an electrolyte membrane 4, a fuel channel layer 5 serving a channel through which a fuel is fed to the fuel electrode, and an oxygen channel layer 6 serving as a channel through which oxygen is fed to the oxygen electrode, with a casing (not shown) covering the periphery thereof. The fuel electrode 2 is constituted of a hydrogen separation membrane 7 and a catalyst 8.

A power generating system will be explained by using an instance where an organic hydride used as a hydride is provided as a fuel that is fed to the fuel cell 1.

The fuel cell 1 is such that, when an organic hydride 14 is fed to the fuel electrode 2, the dehydrogenation proceeds on the catalyst 8 to generate hydrogen. When the generated hydrogen comes in contact with the hydrogen separation membrane 7, protons (H⁺) diffuse into the hydrogen separation membrane 7 and the electrolyte membrane 4, and move toward the oxygen electrode 3.

On the other hand, electrons taken out from the hydrogen result in electric generation after passage via an outside electric wiring. The protons (H⁺), electrons and oxygen combine at the oxygen electrode to produce water.

In the course of the dehydrogenation of the organic hydride 14, the dehydrogenation undergoes thermodynamic limitation. The dehydrogenation of the organic hydride 14 is an endothermic reaction. The smaller partial pressures of hydrogen and aromatic hydrocarbon produced at high temperatures, the equilibrium moves toward the dehydrogenation side. In contrast, the larger partial pressures of hydrogen and the aromatic hydrocarbon at low temperatures, the equilibrium moves toward the hydrogenation side, thereby making it difficult to collect hydrogen. Accordingly, although the storage of hydrogen easily proceeds at low temperatures, a hydrogen supply ascribed to the dehydrogenation is difficult.

The conversion ratio is determined according to an equilibrium between the dehydrogenation and the hydrogenation. With 250° C., a thermodynamically calculated conversion ratio of an organic hydride 14 is at about 30% for methylcyclohexane and at about 50% for decalin. In order to permit the dehydrogenation reaction to further proceed at a temperature of 250° C., it is necessary to control the equilibrium partial pressure. A typical one is a control method using a hydrogen separation membrane wherein generated hydrogen is removed to outside of the reaction system to lower a partial pressure of hydrogen, so that the equilibrium of the reaction can be moved toward a direction where hydrogen is generated. However, only a reduced effect is expected unless the hydrogen separation membrane and the catalyst are disposed adjacently to each other.

The fuel electrode 2 embodying the invention is illustrated with reference to FIG. 2. The hydrogen separation membrane 7 and the catalyst 8 are arranged so as to be intimately contacted through a bonding film 15.

The catalyst 8 is either a dehydrogenation catalyst or a hydrogenation catalyst wherein hydrogen is generated or stored by utilizing the dehydrogenation or hydrogenation between a hydrogen donor changing to a dehydride by releasing hydrogen and a hydrogen absorbing medium consisting of a hydride that reacts with the hydrogen to store the hydrogen. The catalyst has a structure in which a porous oxide film of a metal oxide is formed on a surface of the hydrogen separation membrane 7 as a catalyst carrier. Thus, the surface of the hydrogen separation membrane 7 is partially exposed to at the interface between the hydrogen separation membrane 7 and the porous oxide film.

The catalyst 8 is constituted of a metal catalyst and a carrier material for the metal catalyst. The metal materials include catalysts of metals such as Ni, Pd, t, Rh, Ir, Re, Ru, Mo, W, V, Os, Cr, Co, Fe, Cu and the like, and alloys thereof. Methods of preparing the catalyst materials include a co-precipitation method, a thermal decomposition method and the like and are not specifically limited.

As a catalyst carrier material, it is possible to use porous niobium oxide, zirconium oxide, tantalum oxide, aluminium oxide, sodium niobate, potassium niobate, lithium niobate, sodium tantalate, potassium tantalate, lithium tantalate and the like. Alternatively, it may be possible to use composite materials of the above materials, and those materials comprising a substrate of the above-mentioned porous metal oxide, and silica or another alumina silicate, such as zeolite, added to inside of pores thereof, thereby enabling the acidity of the carrier surface and the absorptive capacity relative to fuel to be controlled.

For the formation of the catalyst carrier, it is possible to use a sol-gel method, a solution process such as of anodization, or a dry process such as a vapor deposition method, a sputtering method, a CVD method or the like. Alternatively, flame spray coating may be used for the formation. For instance, when a catalyst carrier is formed by anodization, niobium, zirconium, tantalum or aluminium metal is formed as a film on one surface of the hydrogen separation membrane by a method such as of non-aqueous plating, pressure bonding, vapor deposition, sputtering, dipping or the like, followed by anodization to form a porous oxide film. This is preferred because the adhesion and thermal conductivity between the hydrogen separation membrane and the catalyst carrier are good.

Where aluminium is formed as a film on the surface of the hydrogen separation membrane 7, the surface of aluminium is anodized and the resulting fine pores formed by the anodization are enlarged, followed by boehmite treatment and baking to use the resulting film as a carrier. This is preferred because the surface area of the carrier increases and an amount of a supported catalyst can be increased over the case where only anodization is carried out.

Although the anodization technique of aluminium is a known one and it is possible to use as an electrolytic solution an aqueous solution, for example, of phosphoric acid, chromic acid, oxalic acid, sulfuric acid or the like. In order to avoid catalyst poisoning, it is preferred to use an aqueous solution of phosphoric acid, chromic acid or oxalic acid. The pore size and thickness of the porous layer formed by the anodization can be appropriately set depending on the conditions including an applied voltage, a treating temperature, a treating time and the like. Preferably, the pore size ranges 10 nm-300 nm and the thickness ranges 5-300 μm. The treating solution temperature of the anodization ranges 0-50° C., preferably 30-40° C. Although the anodization time differs depending on the treating conditions and the thickness to be formed, an anodization layer of 100 μm in thickness can be formed, for example, by treatment for 7 hours in the case where an aqueous solution of 4 wt % of oxalic acid is provided as an electrolytic solution and a treating bath temperature is at 30° C. and an applied voltage is at 40V.

Moreover, an anodized film surface is treated by use of an acid aqueous solution dissolving phosphoric acid, oxalic acid or the like and the resulting fine pores are enlarged, followed by boehmite treatment. The concentration of the acidic aqueous solution preferably ranges 5-20 wt %, for example, for phosphoric acid and the treatment is carried out at 10° C.-30° C. for 10 minutes-3 hours until the size of the fine pores is appropriately enlarged. After completion of the anodization, pores may be enlarged by immersion in an anodization bath as they are for a given time. The beohmite treatment is performed in water with a pH of not less than 6, preferably not less than 7, at 50° C.-200° C. and dried, followed by baking. Although the treating time of the boehmite treatment differs depending on the pH and the treating temperature, the time is preferably 5 minutes or over. For instance, when treated in water with a pH of 7, the treatment is carried out for about 2 hours. Baking is effected for the formation of γ-alumina and is generally carried out at 300-550° C. for 0.5-5 hours.

With anodization of niobium, zirconium and tantalum, a porous oxide film such as of aluminium is not ordinarily formed. In the practice of the invention, anodization is carried out in an alkaline aqueous solution of a high concentration of 0.1-5 mols/L as an electrolytic solution thereby enabling the respective porous oxide films to be formed.

For the alkaline aqueous solution, it is possible to use sodium hydroxide, potassium hydroxide, lithium hydroxide and the like. The structure, pore size and thickness of the porous layer formed by the anodization can be appropriately set depending on the conditions including an applied voltage, a treating temperature and a treat tome. For example, where niobium is anodized in a sodium hydroxide aqueous solution at 40° C. for 1 hour, a sponge-shaped porous niobium oxide film having a pore size of 8 nm and a thickness of 1 μm for 0.1 mol/L can be formed, and a mesh-shaped porous sodium niobate film having a pore size of 60 nm-80 nm and a thickness of 1 μm can be formed for 5 mols/L. Besides, with zirconium and tantalum, the respective porous oxide films can be formed by anodization in alkaline aqueous solutions of similar high concentrations.

It will be noted that the porous meal oxide is defined such that although no limitation is placed on the shape and porosity, pores are not closed-cell pores, but open-cell pores. The crystallinity can be properly controlled by thermal treatment of the resulting porous oxide film.

After formation of a porous metal oxide film on the surface of the hydrogen separation membrane 7 according to the method set out above, the surface of the hydrogen separation membrane 7 is partially exposed. Where the porous metal oxide film is formed by anodization, a dense metal oxide film, i.e. a barrier layer, is formed between the hydrogen separation membrane 7 and the porous oxide film. In order to expose the surface of the hydrogen separation membrane 7, it is necessary to remove the barrier layer.

It will be noted that an exposed area of the hydrogen separation membrane 7 can be controlled by immersing a once formed porous metal oxide film in 5 mols/L of sodium hydroxide and controlling a treating time.

An aperture ratio defined herein is a value obtained by dividing an area of an exposed portion of the hydrogen separation membrane 7 at the interface between the catalyst carrier and the hydrogen separation membrane 7 by a fully exposed area. The aperture ratio can be estimated by a current value of an electrochemical reaction such as of hydrogen generation at the exposed portion of the hydrogen separation membrane 7. The exposed portion of the hydrogen separation membrane 7 functions as a passage hole of hydrogen and also functions as a reaction surface of the electrochemical reaction.

The hydrogen separation membrane 7 used may be made of a metal film such as of Pd, a Pd—Ag alloy, a Ni—V alloy, a Ni—Zr alloy, a Ni—Nb—Ti alloy or the like. Moreover, a composite film may be used, in which a very thin metal film as used above is formed on the surface of a porous ceramic. Preferably, a Ni—Nb—Ti alloy is used. The Ni—Nb—Ti alloy is more inexpensive than an Ag—Pd alloy and has excellent hydrogen permeability similar to the Ag—Pd alloy. These films should preferably be ones whose thickness is as thin as possible because a greater thickness results in a reduced hydrogen permeation velocity. The use of a thicker film can lead to an increasing hydrogen permeation velocity provided that the pressure at the permeation side of hydrogen is made lower than a pressure at the reaction side.

These hydrogen separation membranes 7 can be made by use of film-forming methods such as a rolling method, a solution method, a vapor deposition method, a sputtering method and the like. With the solution method, a plating process may be used and films can be formed by an electroless plating or electroplating method.

In the embodiment of the invention, the electrolyte membrane 4 is formed on the hydrogen separation membrane 7 of the fuel electrode 2. Although the electrolyte membrane 4 may be formed of a known proton conductive solid polymer membrane, it is more preferred to use a heat-resistant proton conductive solid oxide membrane.

For instance, it is possible to use a ceramic proton conductive membrane of a system to which BaCeO₃, SrCeO₃ or a rare metal is added. When using a process where an electrolyte is formed as a membrane on the surface of the hydrogen separation membrane 7, the electrolyte membrane 4 can be satisfactorily thinned to an extent of about 0.1-1 μm. Thereby, the membrane resistance can be significantly reduced and the working temperature of a fuel cell can be lowered.

The hydrogen separation membrane 7 according to the embodiment of the invention has a function as an electrode, aside from the function of selectively permeating hydrogen, the protection of an electrolyte membrane and the function of suppressing an output density from lowering by crossover. When the hydrogen formed by the action that a hydride reacts with a dehydrogenation catalyst contacts the hydrogen separation membrane, the resulting protons diffuse into the separation membrane and electrolyte membrane and move toward the oxygen electrode. Electrons generate electricity via an external electric wiring. Water is formed when the protons, electrons and oxygen are combined together at the oxygen electrode 3.

On the other hand, when electric power is supplied from outside, a reaction reverse to the above reaction can proceed. More particularly, when a dehydride and water are supplied to the fuel electrode 2 and the oxygen electrode 3, respectively, protons are produced at the oxygen electrode 3 by electrolysis of water and diffuse into the electrolyte membrane 4 and the hydrogen separation membrane 7, thereby moves toward the fuel electrode 2 side. The protons and dehydride undergo electrochemical reaction on the surface of the exposed hydrogen separation membrane 7 to prepare a hydride.

In the embodiment of the invention, the fuel channel layer 5 and the oxygen channel layer 6 are respectively made of a material of high thermal conductivity. Although their materials are not limited, it is preferable to be materials where a value dividing its thermal conductivity divided thereof by its film thickness is substantially large. Those materials have the divided value of not smaller than 1,000, preferably not smaller than 10,000.

Where the dehydrogenation is an endothermic reaction, the greater the thermal conductivity and the thinner the film thickness, the catalyst can be heated by effective use of waste heat and combustion heat. Where the dehydrogenation reaction is an exothermic reaction, the catalyst 8 can be efficiently cooled. As a high thermal-conductive material, it is made of ceramics such as aluminium nitride, silicon nitride, alumina, mucolite, cordierite and the like, carbon materials such as glassy carbon, porous carbon, graphite sheet and the like, metals such as stainless steel, copper, nickel, aluminium, silicon titanium and the like, and clad materials, and no specific limitation is placed thereon so far as channel processing is possible. Metal materials can be made by cutting or press forming. The carbon material may be obtained by a method where sulfuric acid is poured inbetween layers of natural graphite or the like, heated to 700° C.-800° C. to undergo expansion, after that, the natural graphite undergoes press forming. In place of that, artificial graphite, carbon particles, carbon nanotubes, carbon nanofibers, carbon nanohorns or the like may be obtained by a method where thermosetting resins such as phenolic resins, furan resins, polyimide resins or the like is injection molded or compression molded, and the molded product is carbonized in vacuum or in an atmosphere of an inert gas. Where the fuel channel layer and the oxygen channel layer are formed by laminating a plurality of unit structure made of a ceramic material as an insulating material, an external electric wiring has to be arranged so as to ensure electric conduction between the respective unit structures. Where a carbon material or a metal is used as a fuel channel layer and oxygen channel layer, the respective channel layers have a function of ensuring electric conduction between the respective unit structures, thereby no external electric wiring is needed. Accordingly, this is a more preferred embodiment.

The channel patterns of the fuel channel layer 5 and the oxygen channel layer 6 of the fuel cell 1 are designed so as to provide a continuous pattern that allows a hydride or dehydride to pass from an inlet to an outlet thereof.

The channel of the fuel channel layer 5 has no specific limitation on the numbers of the inlets and outlets so far as an appropriate flow rate is ensured. The pattern of the fuel channel is appropriately designed so that a flow resistance of fluid is adjusted by changing a width and depth of the channel, depending on the properties such as a boiling point and a viscosity of a hydride or dehydride used. The appropriately designed channel makes it possible to supply the fuel so as to ensure uniform in-plane of the catalyst.

More preferably, the channel width and depth are reduced to the order of microns or nanometers to efficiently supply a fuel to the respective catalysts for carrying out the reactions. Hydrogen is efficiently separated by means of hydrogen separation membranes adjacent to the catalyst and an equilibrium partial pressure control can be easily made.

In the convex shape of the channel pattern in cross section, there is no particular limitation, it may be square, circle or the like in cross section. For the pattern formation, there can be used mechanical processing such as cutting, pressing and the like, and for finer pattern formation, it is possible to use etching, plating and soft lithography such as a nanoprinting process. Alternatively, dry processes such as a vapor deposition, a sputtering process and the like may be used. Heater wires may be embedded inside the fuel channel layer 5 and the oxygen channel layer 6. Where materials for the fuel channel layer 5 and the oxygen channel layer 6 are made of metals, heater wires are insulated around them so as to prevent short-circuiting. When an electric current is applied to the heater wires from outside during startup of operations at which no waste heat generates, the catalyst 8 can be heated to a given temperature.

The respective above-mentioned members may be made by initially forming them in batch mode on a large-area scale and cutting out into small pieces.

Where the respective members are laminated, they should be sealed at outer peripheral portions thereof. As to the sealing materials, no limitation is placed thereon so far as hydrogen and a liquid are not leaked and metals, ceramics, glass, resin materials and the like are usable. Sealing may be carried out by coating or by a melting method. When materials, such as a solder, employed for circuit implementation are used, an implementation process such as reflow may be used. Moreover, where metals are used as the respective members, bonding techniques such as diffusion bonding, friction agitation joining and the like may be used.

The fuel cell 1 according to the embodiment of the invention can be fabricated using the fuel electrode 2 and the respective members. A lamination structure wherein the fuel channel layer 5 is laminated on a surface side of the fuel electrode 2 where the catalyst 8 is formed, and the electrolyte membrane 4, oxygen electrode 3 and oxygen channel layer 6 are successively laminated on a surface side of the hydrogen separation membrane 7 where the catalyst 8 is not formed is provided as a unit structure. A plurality of layers is laminated to provide a stack, which is covered around it with a casing to provide a fuel cell.

The respective members have thicknesses as small as 1 mm or below and they are designed in a small-sized and thin type. The casing is provided at portions thereof with a fuel inlet port passing to the fuel channel of the fuel channel layer, a fuel outlet port for a fuel changed into a waste fluid, an oxygen inlet port passing to the oxygen channel of the oxygen channel layer, and a water discharge port. The fuel inlet port and the fuel outlet port are connected to an external fluid storage tank. The oxygen inlet port is connected to an oxygen feeder such as a compressor, and a water discharge port is connected to a tank such as a water storage tank. For the feed of fuel, a pump is used to feed the fuel while controlling a feed rate such as by a mass flowmeter or the like.

The fuel cell embodying the invention, when being operated at 300-400° C., ensures an efficient operation as a whole of the system because during steady operations, heat generated inside the cell upon generation of electricity compensates for an absorption of heat caused by the dehydrogenation reaction. At the time of startup of the operations, heat has to be given from outside. If the lower part of the casing is provided with a combustion chamber for combusting residual hydrogen or an aromatic compound produced after dehydrogenation, stable operations are ensured before steady operations are to be established.

The fuel cell can be applied to consumer distributed power supplies and automobiles.

The fuel electrode of the invention can function merely as a catalyst for hydrogen supply or hydrogen storage. The fuel electrode has a structure of that: a metal oxide serving as a catalyst carrier is directly formed on the surface of the hydrogen separation membrane; the surface of the hydrogen separation membrane surface is partially exposed at the interface between the catalyst carrier and the hydrogen separation membrane so that the hydrogen can pass through the hydrogen separation membrane. Such a structure enables to efficiently generate hydrogen and supply the hydrogen to existing fuel cells, turbines, internal combustion engines and the like by feeding a hydride to the catalyst.

Next, explanation will be done for the fuel electrode with the catalyst made by using the above-mentioned members and procedures and having the dehydrogenation function or hydrogenation function, a fuel cell using the catalyst, and a hydrogen storage/supply device.

FIG. 3 shows a schematic sectional view of a fuel electrode. A metal oxide 102 serving as a catalyst is formed on a hydrogen separation membrane 103. Fabricated fuel electrodes are shown in Table 1.

Fuel electrodes 101 of Examples 1-14 indicated in Table 1 are those fuel electrodes made using different types of metal oxides 102 and different types of hydrogen separation membranes 103 with different aperture ratios of the hydrogen separation membranes. The respective fuel electrodes were made according to the following procedure.

A 100 μm thick aluminium metal was formed as a film by thermo-compression bonding to one surface of a 80 μm thick Ag—Pd alloy film in vacuum at a given temperature.

Subsequently, a 4 wt % oxalic acid aqueous solution was provided as an electrolyte solution and the aluminium on the surface of the hydrogen separation membrane was fully converted to a porous aluminium oxide film by treatment at a treating bath temperature of 30° C. at an applied voltage of 40 V for a given time. The pore size of the porous aluminium oxide film was at 80 nm. This member was immersed in a 5 mols/L sodium hydroxide aqueous solution for a given time to enlarge pores of the porous oxide film and also to remove the barrier layer by dissolution. At this stage, the aperture ratio of the hydrogen separation membrane was at 50%.

The aperture ratio of the hydrogen separation membrane was controlled by changing an immersion time. Finally, a fuel electrode was made by dipping in a 4 wt % Pt colloid (particle size: 2 nm) solution and baking at 450° C.

Another fuel electrode was made by sputtering a 1 μm thick niobium metal on one surface of a 300 μm thick NiNbTi alloy film. This member was anodized in a 0.1 mol/L sodium hydroxide aqueous solution at 30° C. at 100 V for a given time to fully convert the niobium metal into a porous oxide film. A sponge-shaped porous niobium oxide film having a pore size of 8 nm and a thickness of 1 μm could be formed. Thereafter, the film was immersed in a 5 mols/L sodium hydroxide aqueous solution for a given time, thereby making an aperture ratio of the hydrogen separation film of 50%. Where an alkali metal niobate salt was prepared for use as a catalyst carrier, anodization was carried out in a 5 mols/L sodium hydroxide aqueous solution at 30° C. at 20 V for a given time to provide a porous oxide film. As a result, a mesh-shaped porous sodium niobate film having a pore size of 60 nm-80 nm and a thickness of 1 μm could be formed. Next, a 100 nm thick palladium film was formed selectively on the surface of the hydrogen separation film by electroplating.

Finally, a fuel electrode was made by immersion in a 4 wt % Pt colloid solution (particle size: 2 nm) and baking at 450° C.

The preparation of zirconium oxide, tantalum oxide and an alkali metal tantalate salt used as a catalyst carrier was made in conformity with such a procedure as set out above.

In order to evaluate the catalytic performance of the respective fuel electrodes thus made, a hydrogen storage/supply device 110 of FIG. 4 was made for carrying out a dehydrogenation test.

The hydrogen storage/supply device 110 shown in FIG. 4, casings 113 were, respectively, provided at an upper side of a fuel channel layer 111 and at a lower side of a hydrogen channel layer 112 and were further provided with a fuel inlet port 114 passing to a fuel channel and a fuel outlet port 115. Moreover, a hydrogen passage port 116 passing to a hydrogen channel was provided.

The thus made fuel electrode was held from both sides thereof with the fuel channel layer 111 and the hydrogen channel layer 112, which were made by etching one side surface of an 0.5 mm thick aluminium with a FeCl₃/HCl solution for channel formation, and the outer periphery thereof was sealed. This was covered with aluminium casings 113 to make the hydrogen supply device. 2 mmφ through-holes were made so as to communicate the fuel inlet port 114 with the fuel outlet port 115 of the fuel channel layer and also the hydrogen passage port 116 of the hydrogen channel layer. The width and depth of the channels were, respectively, set at 300 and 100 μm, and a straight line directing from the fuel inlet port toward the outlet port was formed.

These devices were mounted on a ceramic heater provided as an external heat source and heated to 250° C. to carry out the dehydrogenation of methylcyclohexane. The results (conversion (%)) of dehydrogenation is shown in Table 1. All of the fuel electrodes showed the results exceeding an equilibrium conversion at 250° C.

When using metal oxides as a catalyst carrier, diffusion of a hydride from the catalyst carrier toward a catalyst metal and desorption of an aromatic compound formed as a product are more facilitated when compared with the case using a carbon material such as active carbon or the like. The velocity of hydrogen generation can be increased, and the resulting hydrogen quickly moves through the porous metal oxide to the hydrogen separation membrane, followed by discharge to outside of the reaction system. Thus, an effect of high reactivity at low temperatures was realized.

TABLE 1

| | | | Hydrogen | Aperture | | |
|---|---|---|---|---|---|---|
| | Catalyst | Catalyst | separation | ratio | | Conversion |
| Example | metal | carrier | membrane | (%) | Hydride | ratio (%) |
| Example 1 | Pt | Al₂O₃ | AgPd | 50 | Methylcyclohexane | 71 |
| Example 2 | | Al₂O₃ | AgPd | 30 | | 64 |
| Example 3 | | Al₂O₃ | AgPd | 70 | | 83 |
| Example 4 | | Nb₂O₅ | NiNbTi | 50 | | 75 |
| Example 5 | | Nb₂O₅ | NiNbTi | 30 | | 67 |
| Example 6 | | Nb₂O₅ | NiNbTi | 70 | | 87 |
| Example 7 | | NaNbO₃ | NiNbTi | 30 | | 58 |
| Example 8 | | LiNbO₃ | NiNbTi | 30 | | 75 |
| Example 9 | | KNbO₃ | NiNbTi | 30 | | 78 |
| Example | | ZrO₂ | NiNbTi | 30 | | 72 |
| 10 | | | | | | |
| Example | | Ta₂O₅ | NiNbTi | 30 | | 66 |
| 11 | | | | | | |
| Example | | NaTaO₃ | NiNbTi | 30 | | 52 |
| 12 | | | | | | |
| Example | | LiTaO₃ | NiNbTi | 30 | | 70 |
| 13 | | | | | | |
| Example | | KTaO₃ | NiNbTi | 30 | | 73 |
| 14 | | | | | | |

Similar effects were obtained when using other types of organic hydrides.

Where a borohydride was used as a hydride, similar effects were obtained as a result that the dehydrogenation was carried out by using, as a catalyst metal, an Ni—Co alloy in place of Pt. With the case using biomethanol, similar results were obtained as a result that the dehydrogenation was carried out by using a Co—Cu alloy as a catalyst metal.

Additionally, when a heat exchanger is appropriately mounted to the hydrogen storage/supply device of the embodiment of the invention, a more efficient system can be established through the heat exchange between a supplied fuel and the heated waste fluid or heated water discharged from the hydrogen storage/supply device.

Additionally, when a used dehydride and water are fed to the fuel electrode and oxygen electrode of the hydrogen storage/supply device of the embodiment of the invention and electrolyzed by means of midnight power or electric power generated by reproducible energies, the dehydride can be hydrogenated to reproduce a hydride.

The hydrogen storage/supply device of the embodiment of the invention may be utilized only for hydrogen storage or only for hydrogen supply. When the reaction temperatures for the dehydrogenation and hydrogenation are, respectively, controlled, functions of both hydrogen storage and supply can be performed.

Like the fuel cell, the hydrogen storage/supply according to the embodiment of the invention can be systemized by additional attachment of peripheral equipment such as a fuel feed unit, a tank unit, a heat exchanger and the like. A combination of this system and a known electric generator or a motor selected from a fuel cell, a turbine, an engine enables a distributed power supply to be established. In this connection, the hydrogen storage device or hydrogen supply device may be disposed to the electric generator or motor, so that waste heat therefrom can be effectively used for hydrogen storage or hydrogen supply.

Next, a schematic sectional view of a lamination structure of a fuel cell using the fuel electrode illustrated in the embodiment of the invention is shown in FIG. 5.

A fuel cell 200 is comprised of a fuel electrode 101, a fuel channel layer 111, an electrolyte membrane 201, an oxygen electrode 202 and an oxygen channel layer 203. The fuel channel layer 111 is provided, at portions thereof, with a fuel inlet port 114 and a fuel outlet port 115, both passing to the fuel channel, which are connected to an external fluid storage tank (not shown).

On the other hand, the oxygen channel layer 203 is provided, at portions thereof, with an oxygen inlet port 204 and an outlet port 205, both passing to the oxygen channel.

The fuel is supplied by use of a pressure pump capable of intermittent control while controlling a flow rate with a mass flowmeter. The fuel passes through the fuel channel of the fuel channel flow layer 111 and undergoes dehydrogenation while contacting a catalyst thereby producing hydrogen. The thus produced hydrogen comes in contact with a hydrogen separation membrane 103, whereupon protons diffuse into the hydrogen separation membrane 103 and the electrolyte membrane 201 and moves toward the oxygen electrode 202. Electrons generate electricity through an external electric wire.

Water is formed by combining the protons, electrons and oxygen at the oxygen electrode 202. With hydrogenation, a dehydride is fed from the fuel outlet port 115 to the fuel channel and water is fed from the outlet port 205 to the oxygen channel, under which when electric power is applied from outside, protons are produced by electrolysis of water at the oxygen electrode 202. Protons diffuse into the electrolyte membrane 201 and hydrogen separation membrane 103 and moves toward the fuel electrode 101 side. The hydrogen and dehydride are reacted on the exposed surface of the hydrogen separation membrane 103 to prepare a hydride.

The electrolyte membrane is a proton conductive membrane and is made of a solid polymer membrane or solid oxide membrane, of which it is preferred to use a solid oxide membrane.

Examples made as the fuel cell 200 shown in FIG. 5 are summarized in Table 2.

As to the fuel cells 200 of Examples 15-28, the fuel electrodes 101 made in Examples 1-14 and the procedure therefor are explained below. According to the procedure set out in Example 1-14, aluminium, niobium, tantalum and zirconium metal films were, respectively, formed at a 60×60 mm² central portion of the respective 80×80 mm² hydrogen separation membranes 103, followed by anodization to provide porous metal oxide films.

Next, the hydrogen separation membrane was treated to have a given aperture ratio, and a 100 nm thick palladium film was formed on the exposed portion of the hydrogen separation membrane. Thereafter, using BaCeO₃ as a target, a 80×80 mm², 1 μm thick electrolyte membrane 201 was formed according to a laser abration method on the surface of the hydrogen separation membrane where no catalyst carrier was formed. Subsequently, a fuel electrode 101 was made by immersion in a 4 wt % Pt colloid solution (particle size: 2 nm) and baking at 450° C. Next, a cathode paste was coated by a screen printing method and dried to form an oxygen electrode 202, thereby making an electrode assembly 206.

The electrode assembly 206 was held from opposite sides thereof with a fuel channel layer 111 and an oxygen channel layer 203 whose channels were formed on one side surface of 0.5 mm thick aluminium by etching with a FeCl₃/HCl solution, followed by sealing at an outer periphery thereof. This was covered with an aluminium casing 113 to provide a fuel cell 200. 2 mmφ through-holes were formed for communicating the fuel inlet port 114 with a fuel outlet port 115 of the hydrogen channel layer 111 and also communicating the oxygen inlet port 204 with the outlet port 205 of the oxygen channel layer 203. The width and depth of the channels were, respectively, at 300 and 100 μm, and a straight line directing from the fuel inlet port toward the discharge port was formed.

This fuel cell has a size of 90×90 mm² with a thickness of 5 mm. During startup of operations, the fuel cell was mounted on a ceramic heater provided as an external heat source and heated to 300° C. The fuel used was an organic hydride and was fed to the device for electric generation. The results are shown in Table 2. All of the devices exhibit high output densities.

In the course of steady operations, continuous operations could be performed by the heat generated by the electric generation substantially without heat supply from outside. In this way, the fuel cell of the invention has excellent mobility in that quick heat transmission from the external heat source to the catalyst layer is possible during startup of operations. Under stationary conditions, heat generated in the cell compensates for absorption of heat caused by the dehydrogenation, with the attendant effect that the fuel cell can be operated efficiently. When the electrolyte was formed as a film on the surface of the hydrogen separation membrane, the electrolyte membrane could be well thinned in about 0.1-1 μm, so that the membrane resistance could be significantly reduced and the operating temperature of the fuel cell could be made low. Moreover, using a metal oxide as a catalyst carrier, diffusion of a hydride from the catalyst carrier to the catalyst metal and desorption of an aromatic compound formed as a product were more facilitated over the case using a carbon material such as active carbon. Thus, the velocity of hydrogen generation reaction could be increased, once generated hydrogen could be quickly moved to the hydrogen separation membrane and electrolyte membrane via in the porous metal oxide, and a high output density could be held without causing a crossover in the electrolyte membrane.

TABLE 2

| | | | | | | Maximum |
|---|---|---|---|---|---|---|
| | | | Hydrogen | | | output |
| | Catalyst | Catalyst | separation | Aperture | | density |
| Example | metal | carrier | membrane | ratio(%) | Hydride | (W/cm²) |
| Example | Pt | Al₂O₃ | AgPd | 50 | Methylcyclohexane | 0.32 |
| 15 | | | | | | |
| Example | | Al₂O₃ | AgPd | 30 | Methylcyclohexane | 0.21 |
| 16 | | | | | | |
| Example | | Al₂O₃ | AgPd | 70 | Methylcyclohexane | 0.34 |
| 17 | | | | | | |
| Example | | Nb₂O₅ | NiNbTi | 50 | Methylcyclohexane | 0.39 |
| 18 | | | | | | |
| Example | | Nb₂O₅ | NiNbTi | 30 | Methylcyclohexane | 0.26 |
| 19 | | | | | | |
| Example | | Nb₂O₅ | NiNbTi | 70 | Methylcyclohexane | 0.41 |
| 20 | | | | | | |
| Example | | NaNbO₃ | NiNbTi | 30 | Cyclohexane | 0.29 |
| 21 | | | | | | |
| Example | | LiNbO₃ | NiNbTi | 30 | Cyclohexane | 0.31 |
| 22 | | | | | | |
| Example | | KNbO₃ | NiNbTi | 30 | Methyl | 0.32 |
| 23 | | | | | decalin | |
| Example | | ZrO₂ | NiNbTi | 30 | Bicyclohexyl | 0.35 |
| 24 | | | | | | |
| Example | | Ta₂O₅ | NiNbTi | 30 | Methylcyclohexane | 0.24 |
| 25 | | | | | | |
| Example | | NaTaO₃ | NiNbTi | 30 | Methylcyclohexane | 0.21 |
| 26 | | | | | | |
| Example | | LiTaO₃ | NiNbTi | 30 | Methylcyclohexane | 0.25 |
| 27 | | | | | | |
| Example | | KTaO₃ | NiNbTi | 30 | Methylcyclohexane | 0.26 |
| 28 | | | | | | |

In addition, the fuel cell of the embodiment of the invention is systemized by attachment, as peripheral devices, of a fuel feed unit feeding a fuel to the fuel cell, and tank units storing a fuel and a waste fluid. Additionally, a heat exchanger may be attached. When the heat exchanger is appropriately arranged, a more efficient system may be established by heat exchange between a fuel to be fed and a heated waste fluid or heated water discharged from the fuel cell.

The fuel cell of the embodiment of the invention can be utilized in automatic dispensers, mobile devices or distributed power supplies for consumer or professional use, and the fuel cell is mounted in automobiles and can drive the motor thereof to run the automobile.

FIG. 6 is a schematic sectional view of a fuel cell wherein the fuel cells of the embodiment of the invention are stacked in five layers. The unit structures of the fuel cell 200 shown in FIG. 5 were stacked in five layers to provide a fuel cell 300 as shown in FIG. 6 and this cell 300 was subjected to an electric generation test, revealing that efficient electric generation could be made.

Next, a comparative example for comparison with the embodiment of the invention is described.

A lamination structure and a fuel electrode 2 of Comparative Example 1 are, respectively, shown in FIGS. 7 and 8.

A fuel electrode 301 is a single cell fabricated by using a fuel electrode 302 shown in FIG. 8, an oxygen electrode 303, an electrolyte membrane 304 made of a 1 μm thick BaCe_{0.4}Y_{0.2}O₃ film formed by a laser abrasion method, and a fuel channel layer 305 and an oxygen channel layer 306, each made of a channel-processed stainless steel.

Incidentally, the fuel electrode 302 is one wherein 15 mm square, 40 μm thick pure palladium was used as a hydrogen separation membrane 307 with its surface being formed with a 5 wt % Pt/active carbon catalyst 308. The fuel electrode 302 and the oxygen electrode 303 were fixed to the respective electrodes by coating by a screen printing method and drying. The respective members were sandwiched between casings 313, followed by sealing with a ceramic bonding agent. Although not shown, a fuel inlet port 309 and a fuel outlet port 310 were connected to the fuel channel layer 305 of the fuel cell 301 and an oxygen inlet port 311 and a discharge port 312 were connected to the oxygen channel layer 306. The fuel inlet port 309 and fuel outlet port 310 were, respectively, connected with fuel tanks (not shown).

The fuel cell 301 was heated to 250° C., and hydrogen or methylcyclohexane was fed to the fuel electrode 2 and humidified air was fed to the oxygen electrode 303. As a result, where hydrogen and methylcyclohexane were fed, the maximum output densities were, respectively, at 0.3 W/cm² and 0.04 W/cm². Where methylcyclohexane was used as a fuel, the output lowered when compared with the case where hydrogen was fed. This is considered as follows: since active carbon was used as a catalyst carrier, diffusion of a hydride from the catalyst carrier to the catalyst metal and elimination of an aromatic compound formed as a product were so slow that hydrogen was not generated efficiently.

This is considered for the reason that as shown in FIG. 8, the surface of the hydrogen separation membrane was covered with the catalyst carrier and hydrogen formed by the action of the catalyst cannot quickly move to the hydrogen separation membrane and electrolyte membrane.

### INDUSTRIAL UTILITY

The fuel cell and the hydrogen storage/supply device of the invention can be utilized as distributed power supplies such as a domestic fuel cell, fuel cell automobiles, hydrogen engine automobiles and the like.

### BRIEF DESCRIPTION OF DRAWINGS

FIG. 1 is a schematic sectional view of a fuel cell embodying the invention.

FIG. 2 is a schematic sectional view of a fuel electrode embodying the invention.

FIG. 3 is a schematic sectional view of a fuel electrode embodying the invention.

FIG. 4 is a schematic sectional view of a hydrogen storage/supply device embodying the invention.

FIG. 5 is a schematic sectional view of a lamination structure of a fuel cell embodying the invention.

FIG. 6 is a schematic sectional view of a fuel cell wherein fuel cells embodying the invention are stacked in five layers.

FIG. 7 is a schematic sectional view of a lamination structure of a fuel cell of Comparative Example 1.

FIG. 8 is a schematic sectional view of a fuel electrode of Comparative Example 1.

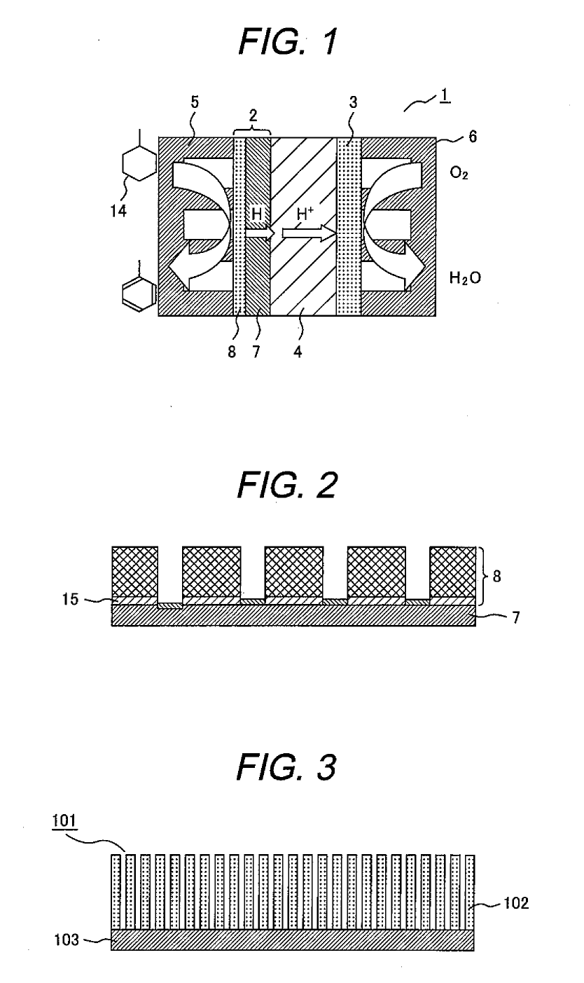

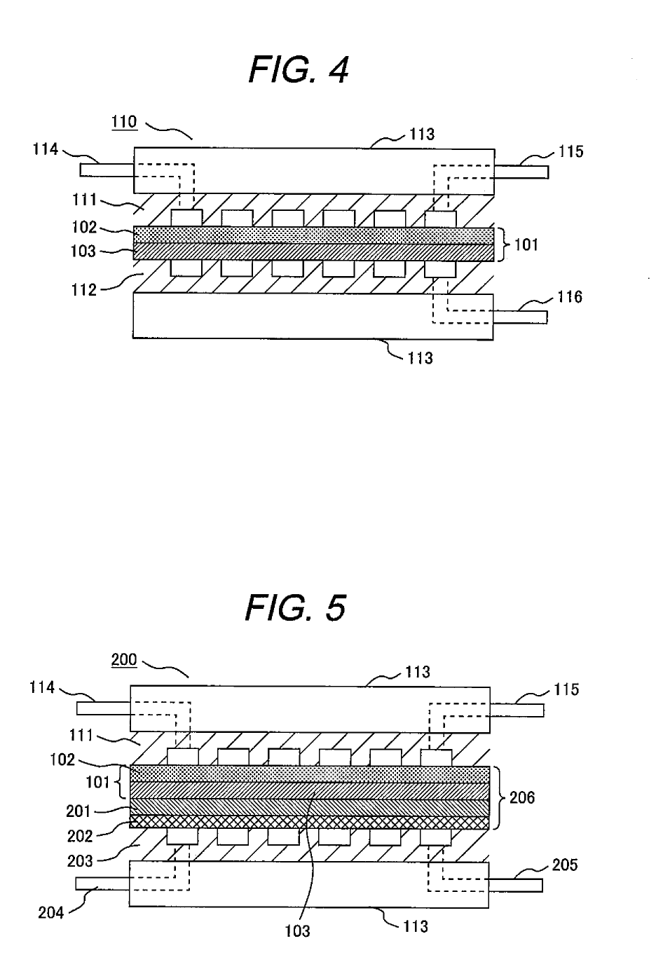

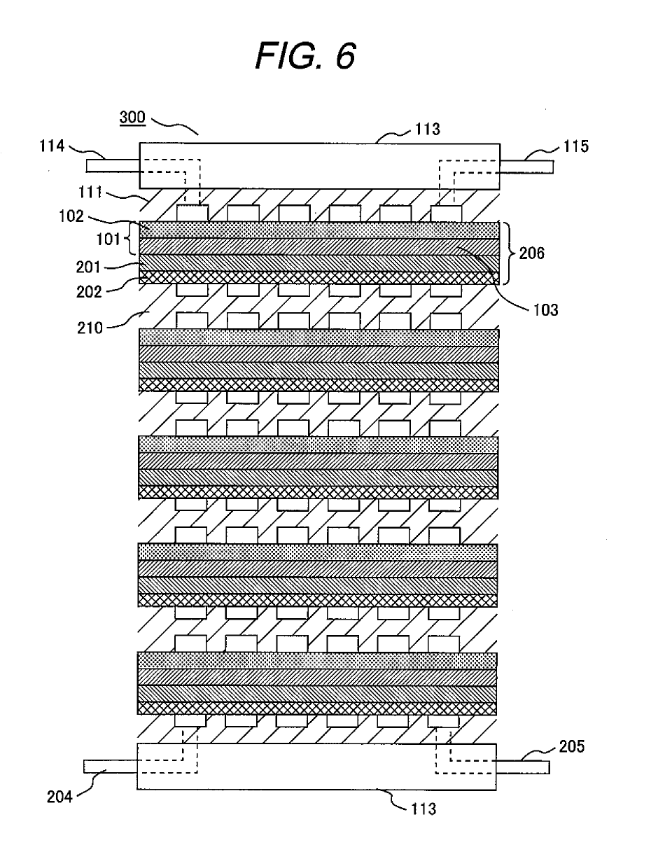

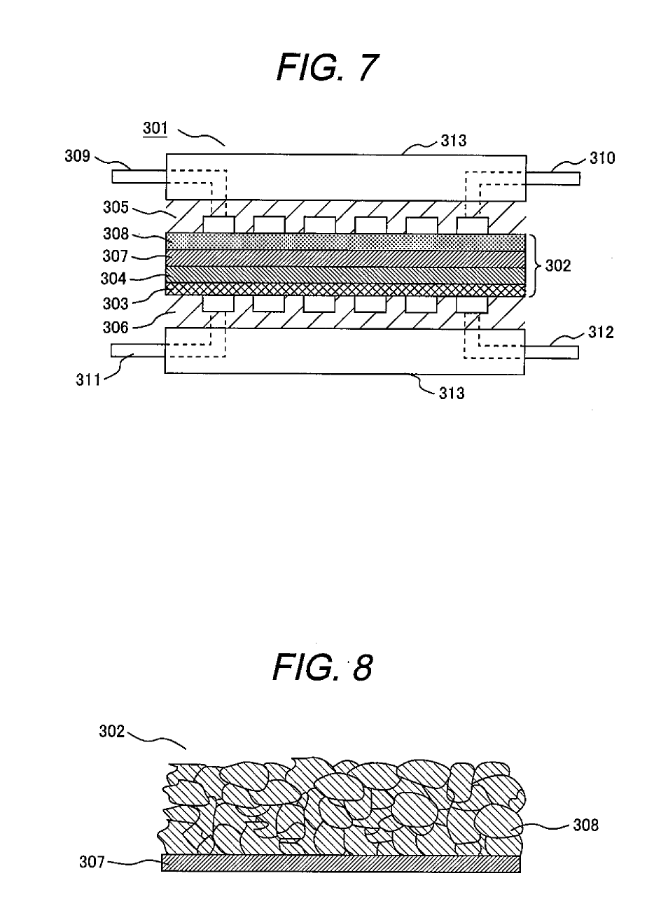

### DESCRIPTION OF REFERENCE NUMERALS

1, 200, 300, 301 . . . fuel cell, 2, 101 . . . fuel electrode, 3, 202 . . . oxygen electrode, 4, 201 . . . electrolyte membrane, 5 . . . fuel channel layer, 6, 203 . . . oxygen channel layer, 7, 103 . . . hydrogen separation membrane, 8 . . . catalyst, 9, 114 . . . fuel inlet port, 10, 115 . . . fuel outlet port, 11, 204 . . . oxygen inlet port, 12 . . . water discharge port, 13 . . . casing, 102 . . . metal oxide, 110 . . . hydrogen storage/supply device, 111 . . . fuel channel layer, 112 . . . hydrogen channel layer, 113 . . . casing, 116 . . . hydrogen passage port, 205 . . . discharge port, 206 . . . electrode assembly, 210 . . . fuel and oxygen passage layer

1. A catalyst having a dehydrogenation function or hydrogenation function wherein hydrogen is generated or stored by utilizing dehydrogenation or hydrogenation between a hydrogen donor changing to a dehydride by releasing hydrogen and a hydrogen absorbing medium consisting of a hydride that reacts with the hydrogen to store the hydrogen,
wherein said catalyst has a porous oxide film of a metal oxide formed on a surface of a hydrogen separation membrane as a catalyst carrier.

2. The catalyst having a dehydrogenation function or hydrogenation function as defined in claim 1,
wherein said hydrogen separation membrane is configured so as to be partially exposed at an interface with said porous oxide film.

3. The catalyst having a dehydrogenation function or hydrogenation function as defined in claim 1,
wherein said catalyst has said porous oxide film of at least one metal oxide selected from a group consisting of niobium oxide, tantalum oxide, zirconium oxide, aluminium oxide, sodium niobate, potassium niobate, lithium niobate, sodium tantalate, potassium tantalate and lithium tantalate as a catalyst carrier.

4. The catalyst having a dehydrogenation function or hydrogenation function as defined in claim 1,
wherein said hydrogen separation membrane is made of palladium, niobium, tantalum, zirconium, vanadium and an alloy containing at least a part thereof.

5. The catalyst having a dehydrogenation function or hydrogenation function as defined in claim 1,
wherein said fuel channel layer or said oxygen channel layer is made of a high heat-conductive material.

6. The catalyst having a dehydrogenation function or hydrogenation function as defined in claim 1,
wherein said hydride is an organic hydride made of at least one of isopropanol, cyclohexane, methylcyclohexane, dimethylcyclohexane, decalin, methyl decalin, tetradecahydroanthracene, bicyclohexyl, and an alkyl-substituted product thereof, or at least one boron hydride compound selected from a group consisting of LiBH₄, NaBH₄, KBH₄ and Ma (BH₄)₂, or at least one selected from a group consisting of bioethanol and biomethanol.

7. A fuel cell comprising a fuel electrode, an oxygen electrode, an electrolyte membrane provided between said fuel electrode and said oxygen electrode, a fuel channel layer provided at said fuel electrode, and an oxygen channel layer provided at said oxygen electrode which are laminated at least one-by-one and covered with a casing,
wherein said fuel electrode comprises a hydrogen separation membrane and a catalyst formed on a surface thereof,
wherein said catalyst includes a porous oxide film of a metal oxide as a catalyst carrier, and is configured to generate hydrogen by utilizing a dehydrogenation between a hydrogen donor changing to a dehydride by releasing hydrogen and a hydrogen absorbing medium consisting of a hydride that reacts with the hydrogen to store the hydrogen.

8. The fuel cell as defined in claim 7,
wherein said hydrogen separation membrane is configured so as to be partially exposed at an interface with said porous oxide film.

9. The fuel cell as defined in claim 7,
wherein said catalyst has said porous oxide film of at least one metal oxide selected from a group consisting of niobium oxide, tantalum oxide, zirconium oxide, aluminium oxide, sodium niobate, potassium niobate, lithium niobate, sodium tantalate, potassium tantalate and lithium tantalate as a catalyst carrier.

10. The fuel cell as defined in claim 7,
wherein said hydrogen separation membrane is made of palladium, niobium, tantalum, zirconium, vanadium and an alloy containing at least a part thereof.

11. The fuel cell as defined in claim 7,
wherein said fuel channel layer or said oxygen channel layer is made of a high heat-conductive material.

12. The fuel cell as defined in claim 7,
wherein said hydride is an organic hydride made of at least one of isopropanol, cyclohexane, methylcyclohexane, dimethylcyclohexane, decalin, methyl decalin, tetradecahydroanthracene, bicyclohexyl, and an alkyl-substituted product thereof, or at least one boron hydride compound selected from a group consisting of LiBH₄, NaBH₄, KBH₄ and Ma (BH₄)₂, or at least one selected from a group consisting of bioethanol and biomethanol.

13. A hydrogen storage/supply device having a laminated composite layer, as a unit structure, comprising a hydrogen separation membrane, a catalyst formed on a surface of said hydrogen separation membrane, a fuel channel layer provided on said catalyst to serve as a channel for a fuel, and a hydrogen channel layer provided to serve as a channel to transfer hydrogen from said hydrogen separation membrane,
wherein said catalyst includes a porous oxide film of a metal oxide as a catalyst carrier, and is configured to generate hydrogen by utilizing a dehydrogenation between a hydrogen donor changing to a dehydride by releasing hydrogen and a hydrogen absorbing medium consisting of a hydride that reacts with the hydrogen to store the hydrogen.

14. The hydrogen storage/supply device as defined in claim 13,
wherein said hydrogen separation membrane is configured so as to be partially exposed at an interface with said porous oxide film.

15. The hydrogen storage/supply device as defined in claim 13,
wherein said catalyst has said porous oxide film of at least one metal oxide selected from a group consisting of niobium oxide, tantalum oxide, zirconium oxide, aluminium oxide, sodium niobate, potassium niobate, lithium niobate, sodium tantalate, potassium tantalate and lithium tantalate as a catalyst carrier.

16. The hydrogen storage/supply device as defined in claim 13,
wherein said hydrogen separation membrane is made of palladium, niobium, tantalum, zirconium, vanadium and an alloy containing at least a part thereof.

17. The hydrogen storage/supply device as defined in claim 13,
wherein said fuel channel layer or said oxygen channel layer is made of a high heat-conductive material.

18. The hydrogen storage/supply device as defined in claim 13,
wherein said hydride is an organic hydride made of at least one of isopropanol, cyclohexane, methylcyclohexane, dimethylcyclohexane, decalin, methyl decalin, tetradecahydroanthracene, bicyclohexyl, and an alkyl-substituted product thereof, or at least one boron hydride compound selected from a group consisting of LiBH₄, NaBH₄, KBH₄ and Ma (BH₄)₂, or at least one selected from a group consisting of bioethanol and biomethanol.
